(19) United States
(12) Patent Application Publication
(10) Pub. No.: US 2022/0092845 A1
(43) Pub. Date: Mar. 24, 2022

(54) INFORMATION PROCESSING APPARATUS, VIEWING APPARATUS, AND NON-TRANSITORY COMPUTER READABLE MEDIUM

(71) Applicant: FUJIFILM Business Innovation Corp., Tokyo (JP)

(72) Inventors: Takuma ISHIHARA, Kanagawa (JP); Jungo HARIGAI, Kanagawa (JP); Hirotake SASAKI, Kanagawa (JP); Yoshitaka KUWADA, Kanagawa (JP)

(73) Assignee: FUJIFILM Business Innovation Corp., Tokyo (JP)

(21) Appl. No.: 17/140,119

(22) Filed: Jan. 3, 2021

(30) Foreign Application Priority Data
Sep. 18, 2020 (JP) 2020-157818

(51) Int. Cl. G06T 15/20; G06T 7/73; G02B 27/01; H04N 13/282

(52) U.S. Cl. CPC G06T 15/20; H04N 13/282; G02B 27/0172; G06T 7/74

(57) ABSTRACT

An information processing apparatus includes a processor configured to cause a display device to display a presentation image that is part of a reference image of a viewing target shot at a predetermined reference position. The presentation image is based on an attitude of the display device used by a user. The processor is also configured to recompose the presentation image when a position of the display device is changed. The presentation image is recomposed on a basis of movement of the display device.

### CROSS-REFERENCE TO RELATED APPLICATIONS

This application is based on and claims priority under 35 USC 119 from Japanese Patent Application No. 2020-157818 filed Sep. 18, 2020.

### BACKGROUND

### (i) Technical Field

The present disclosure relates to an information processing apparatus, a viewing apparatus, and a non-transitory computer readable medium.

### (ii) Related Art

Japanese Unexamined Patent Application Publication No. 2016-62486 discloses an image generating device including a memory, a detecting section, an image processor, and a switching section. The memory stores images of respective surrounding spaces centered at different fixed points. The detecting section detects a translational movement on the basis of the position of a point of view. The image processor acquires an image of a displaying target by clipping out a part of an image of the corresponding surrounding space centered at the fixed point and stored in the memory. The image processor clips out the part on the basis of the position of the point of view and the direction of the line of sight. The different fixed points are arranged in such a manner that the surrounding spaces centered at the respective fixed points overlap each other in the world coordinate system in which the point of view moves. If the detecting section detects a translational movement, the switching section performs switching to an image of a surrounding space among the surrounding spaces that is centered at a different fixed point closest to the point of view after the translational movement.

Japanese Unexamined Patent Application Publication No. 2019-133310 discloses an image processing device that forms a full 360-degree spherical image having a 3D (3D) effect. The image processing device includes a model forming unit and a drawing unit. The model forming unit forms a 3D mesh model by combining mesh shapes based on the characteristics of the full 360-degree spherical image. The drawing unit converts the coordinate values of respective pixels of the 3D mesh model into the coordinate values of the coordinate system of the full 360-degree spherical image on the basis of the coordinate values of a virtual reference point set in a 3D space and the coordinate values of the respective pixels. The drawing unit also maps the full 360-degree spherical image to the 3D mesh model and thereby forms the resultant full 360-degree spherical image.

Japanese Unexamined Patent Application Publication No. 2009-266095 discloses an image processing apparatus including a display, an image drawing unit, a display controller, and a deforming unit. The display presents a predetermined image to a user. The image drawing unit draws a two-dimensional image in the drawing memory. The two-dimensional image represents a field of vision from a predetermined position in a predetermined direction in a virtual field. The display controller cuts out a display area set as a part of the two-dimensional image drawn in the drawing memory and presents the cut out display area to the user by using the display. The deforming unit deforms the two-dimensional image in the drawing memory and thereby generates a deformed image used to present, to the user, a field of vision at the time when a direction of a line of sight from the predetermined position is changed to a left or right direction. The deforming unit includes a movement direction deciding unit, a shift amount deciding unit, and a moving unit. The movement direction deciding unit decides a movement direction in which the line of sight is changed. The image dividing unit divides the two-dimensional image horizontally and generates divided bands. The shift amount deciding unit decides a shift amount of each divided band such that the higher a divided band of the divided bands is located, the larger the shift amount of the divided band is. The moving unit generates the deformed image by shifting each divided band in the decided moving direction in accordance with the decided shift amount. The display controller cuts out the display area in the deformed image and presents the cut out display area to the user by using the display unit.

### SUMMARY

There are systems enabling a user wearing a display device such as a head mounted display to view, for example, the interior of a property. In the system, the display device displays a presentation image that is part of a reference image shot at a predetermined reference position, such as a full 360-degree spherical image of, for example, the interior of the property. The presentation image is based on the attitude of the display device, that is, a direction of the line of sight of the user. This enables, for example, the interior of the property to be viewed virtually.

The reference image such as the full 360-degree spherical image is an image shot at one reference position. Accordingly, for example, even though the position of the display device is changed when the user walks or stands up without changing the line-of-sight direction, the presentation image displayed on the display device is not changed, and thus a presentation image based on the position of the display device after the moving is not displayed.

Aspects of non-limiting embodiments of the present disclosure relate to an information processing apparatus, a viewing apparatus, and a non-transitory computer readable medium that cause a display device used by a user to display a presentation image that is part of a reference image shot as a viewing target and that is based on the attitude of the display device, the information processing apparatus, the viewing apparatus, and the non-transitory computer readable medium being enabled to display a presentation image recomposed on the basis of the position of the display device even after the position of the display device is changed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to cause a display device to display a presentation image that is part of a reference image of a viewing target shot at a predetermined reference position. The presentation image is based on an attitude of the display device used by a user. The processor is also configured to recompose the presentation image when a position of the display device is changed. The presentation image is recomposed on a basis of movement of the display device.

### BRIEF DESCRIPTION OF THE DRAWINGS

An exemplary embodiment of the present disclosure will be described in detail based on the following figures, wherein:

FIG. 1 is a schematic diagram illustrating the configuration of a viewing apparatus;

FIG. 2 is a view for explaining the position and the attitude of a user;

FIG. 3 is a block diagram of an information processing apparatus;

FIG. 4 is a flowchart of the information processing apparatus;

FIG. 5 is a view illustrating an example of a full 360-degree spherical image;

FIG. 6 is a view for explaining a room of which a full 360-degree spherical image is shot;

FIG. 7 is a view for explaining the room of which the full 360-degree spherical image is shot;

FIG. 8 is a view for explaining a relationship between the full 360-degree spherical image and a presentation image;

FIG. 9 is a view for explaining presentation images in different line-of-sight directions;

FIG. 10 is a view for explaining a vanishing point;

FIG. 11 is a view for explaining the movement of the vanishing point;

FIG. 12 is a view for explaining the recomposition of presentation images;

FIG. 13 is a view illustrating an example of a presentation image yet to be recomposed; and

FIG. 14 is a view illustrating an example of a recomposed presentation image.

### DETAILED DESCRIPTION

Hereinafter, examples of an exemplary embodiment to implement the present disclosure will be described in detail with reference to the drawings.

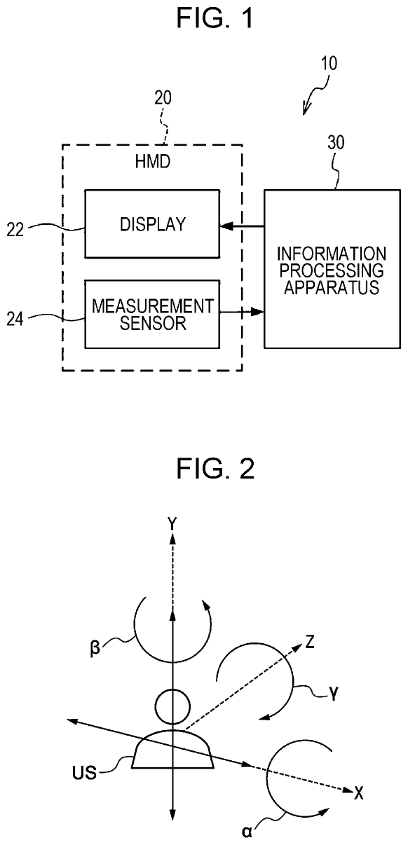

FIG. 1 is a diagram of the configuration of a viewing apparatus 10 according to this exemplary embodiment. As illustrated in FIG. 1, the viewing apparatus 10 includes a head mounted display (hereinafter, HMD) 20 and an information processing apparatus 30. The HMD 20 is an example of a display device.

The HMD 20 is a device for experiencing virtual reality (VR) content. A case where the HMD 20 is a display device for viewing a property as virtual reality content will be described in this exemplary embodiment.

The HMD 20 may be used, for example, in such a manner that a goggles HMD 20 is held by a user US with their hand or that the HMD 20 is equipped with a gear such as a band wearable on the head of the user US without being held with their hand. The form of the HMD 20 is not limited to the goggles and may be a helmet, glasses, or a mobile terminal having a display such as a smartphone.

The HMD 20 includes a display 22 and a measurement sensor 24. The display 22 includes, for example, a liquid crystal display. The goggles HMD 20 is equipped with the display 22 on the inner surface of the goggles. When seeing the inside of the goggles, the user US visually confirms an image displayed on the display 22.

The measurement sensor 24 detects the position, the attitude, the moving distance, and the like of the HMD 20 and includes, for example, a gyrosensor, a magnetic sensor, or an acceleration sensor.

The position of the HMD 20 is expressed by using a position (coordinates) in a 3D space having an X axis, a Y axis, and a Z axis that are orthogonal to each other, as illustrated in FIG. 2. The position of the HMD 20 is hereinafter expressed by using a position (x, y, z).

As illustrated in FIG. 2, the attitude of the HMD 20 is expressed by using a rotation angle α around the X axis as the center axis, a rotation angle β around the Y axis as the center axis, and a rotation angle γ around the Z axis as the center axis. The attitude of the HMD 20 is hereinafter expressed by using an attitude (α, β, γ). Upon detecting the attitude of the HMD 20, a direction in which the HMD 20 faces, that is, a line-of-sight direction is thereby detected.

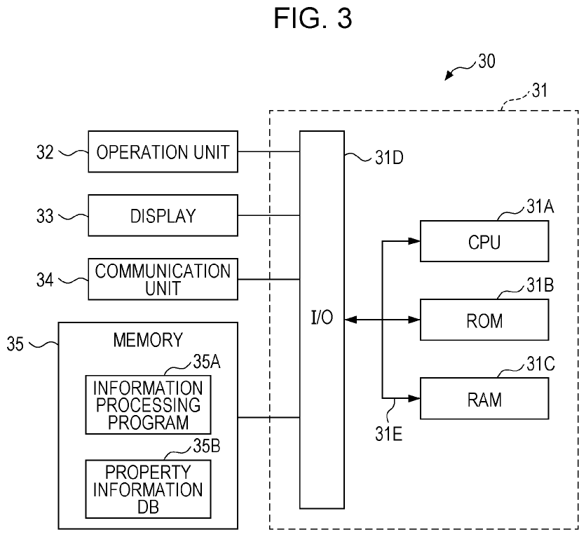

FIG. 3 is a block diagram illustrating the hardware configuration of the information processing apparatus 30. The information processing apparatus 30 includes a general computer.

As illustrated in FIG. 3, the information processing apparatus 30 includes a controller 31. The controller 31 includes a central processing unit (CPU) 31A, a read only memory (ROM) 31B, a random access memory (RAM) 31C, and an input-output interface (I/O) 31D. The CPU 31A, the ROM 31B, the RAM 31C, and the I/O 31D are connected to each other via a system bus 31E. The system bus 31E includes a control bus, and address bus, and a data bus. The CPU 31A is an example of a processor.

An operation unit 32, a display 33, a communication unit 34, and a memory 35 are also connected to the I/O 31D.

The operation unit 32 includes, for example, a mouse and a keyboard.

The display 33 includes, for example, a liquid crystal display.

The communication unit 34 is an interface for performing data communications with an external apparatus such as the HMD 20.

The memory 35 includes a nonvolatile external memory device such as a hard disk and stores an information processing program 35A (described later), a property information database 35B, and other components. The CPU 31A loads the information processing program 35A stored in the memory 35 in the RAM 31C and runs the information processing program 35A.

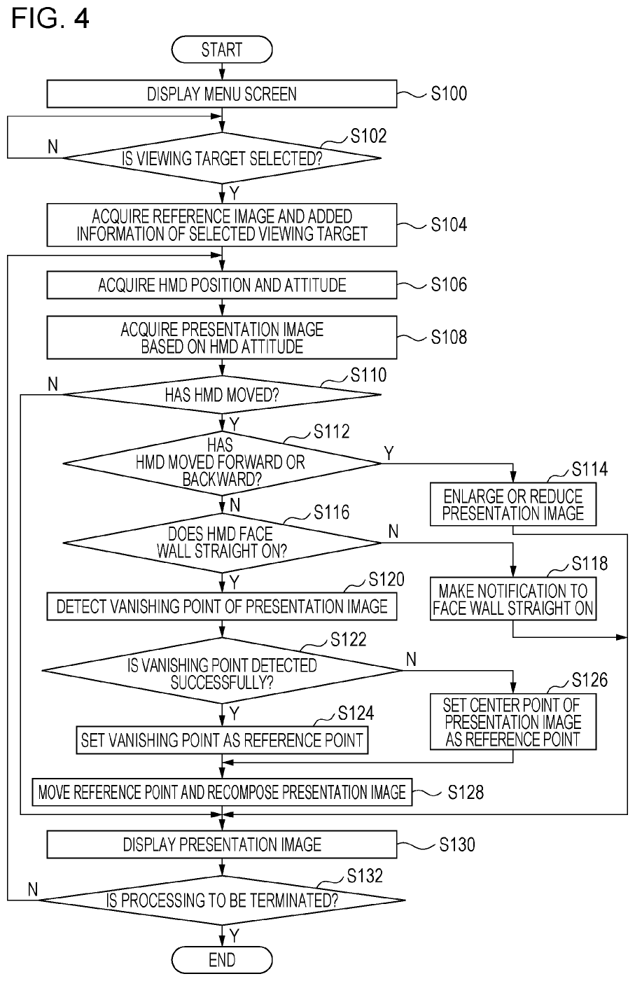

Actions of the information processing apparatus 30 according to this exemplary embodiment will be described with reference to FIG. 4. The CPU 31A runs the information processing program 35A, and information processing illustrated in FIG. 4 is thereby performed. The information processing illustrated in FIG. 4 is performed, for example, when an instruction to run the information processing program 35A is issued in response to an operation by the user.

In step S100, the CPU 31A causes the display 33 to display a menu screen (not illustrated) for selecting a property that is a viewing target. The user US operates the operation unit 32 to select a property they wish to view and wears the HMD 20.

In step S102, the CPU 31A determines whether a viewing target is selected. If a viewing target is selected, the processing proceeds to step S104. In contrast, if a viewing target is not selected, the CPU 31A waits until a viewing target is selected.

In step S104, the CPU 31A acquires the reference image and the added information of the selected viewing target in such a manner as to read out the reference image and the added information from the property information database 35B of the memory 35. The property information database 35B of the memory 35 stores reference images and added information of various properties in advance.

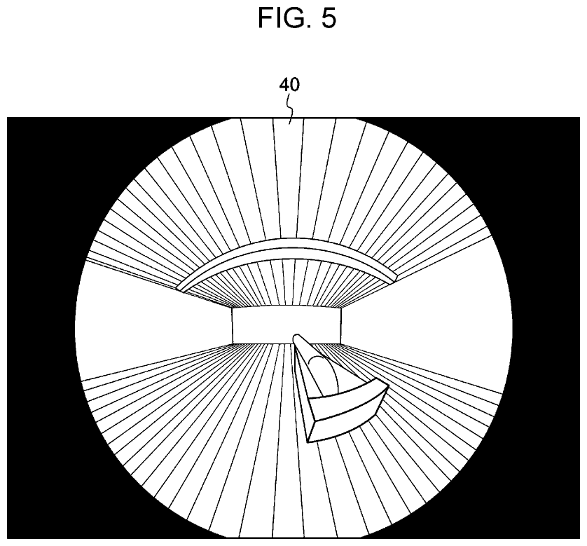

The reference image is an image of the viewing target shot at a predetermined reference position. In this exemplary embodiment, for example, a case where the reference image is a full 360-degree spherical image of the interior of a room of a property as a viewing target is described. The full 360-degree spherical image is shot at a predetermined reference position. The shape of the interior of the room is a cuboid. The full 360-degree spherical image is an image of a 360 panorama view from the reference position. FIG. 5 illustrates a full 360-degree spherical image as an example.

The reference image is not limited to the full 360-degree spherical image. For example, a general image having an aspect ratio of, for example, 4:3 or 16:9 may be used, and a panorama image longer sideways than a general image may also be used. The reference position is desirably, for example, the center of the room but is not limited thereto.

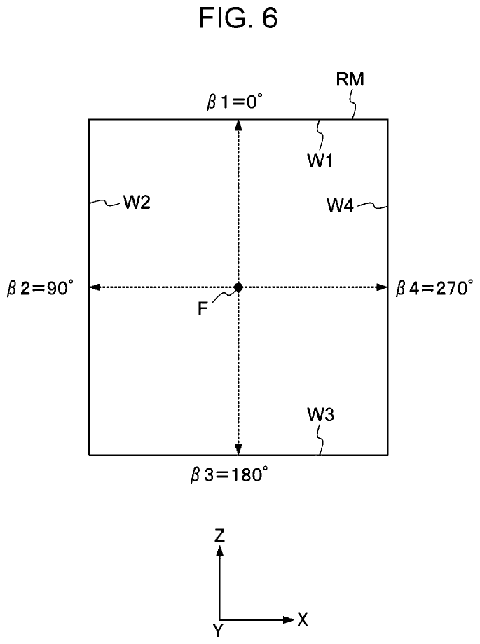

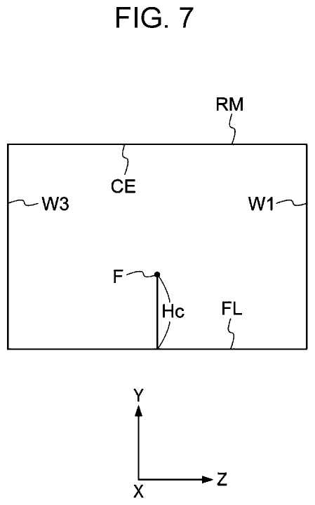

The added information is information regarding a shooting condition at the time when the reference image is shot. Specifically, as illustrated in FIGS. 6 and 7, the added information includes a height Hc [m] from a reference position F at the time of shooting a room RM that is a cuboid from the reference position F with a camera capable of shooting a full 360-degree spherical image. The added information also includes angles formed at the time of facing four respective walls W1, W2, W3, and W4 of the room RM straight on. Specifically, as illustrated in FIG. 6, the added information includes angles β1, β2, β3, and β4 formed around the Y axis at the time of facing the respective walls W1, W2, W3, and W4 straight on. In this exemplary embodiment, the cuboid shape of the room RM as illustrated in FIGS. 6 and 7 leads to β1=0 degrees, β2=90 degrees, β3=180 degrees, and β4=270 degrees.

In this exemplary embodiment, a coordinate system of the 3D space including the HMD 20 corresponds to a coordinate system of the 3D space in which the reference image is shot.

In step S106, the CPU 31A acquires the position (x, y, z) and the attitude (α, β, γ) of the HMD 20 detected by the measurement sensor 24 of the HMD 20.

In step S108, the CPU 31A acquires a presentation image based on the attitude of the HMD 20 acquired in step S106. Note that the presentation image is an image of a part of a reference image of a viewing target shot at a predetermined reference position. The image is based on the attitude of a display device used by a user. Specifically, from the full 360-degree spherical image of the room RM of the property serving as the viewing target shot at the predetermined reference position F, an image in the range based on the attitude of the HMD 20, that is, the direction of the line of sight from the HMD 20 is extracted as the presentation image.

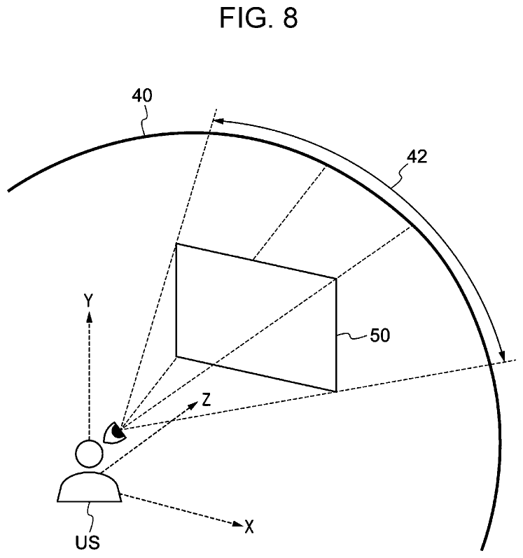

As illustrated in FIG. 8, an image in a range 42 based on the direction of the line of sight from the HMD 20 in a full 360-degree spherical image 40 is extracted as a presentation image 50.

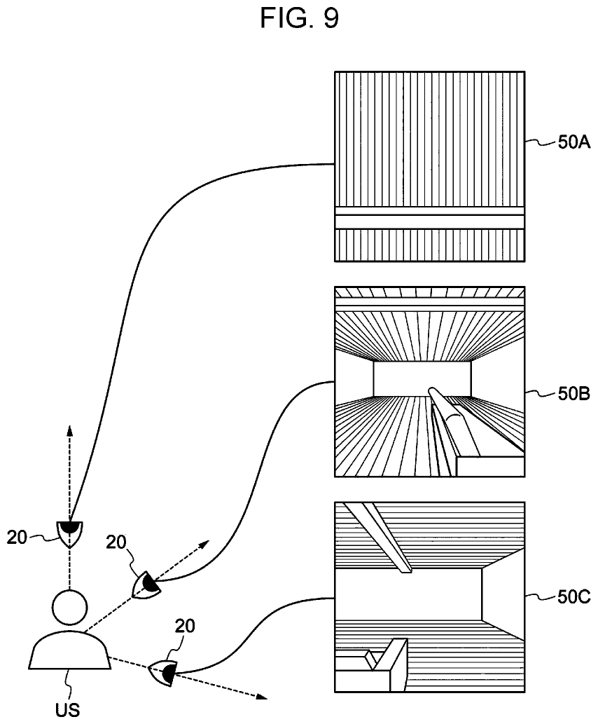

For example, when the line of sight from the HMD 20 extends directly upwards along the Y axis as illustrated in FIG. 9, an image of a ceiling CE of the room RM is extracted as a presentation image 50A. When the line of sight from the HMD 20 extends along the Z axis (a direction in which the HMD 20 faces the wall W1 straight on), an image of the wall W1 of the room RM seen from the front is extracted as a presentation image 50B. When the line of sight from the HMD 20 extends along the X axis, an image of the wall W4 of the room RM seen from the front is extracted as a presentation image 50C.

In step S110, the CPU 31A compares the position of the HMD 20 acquired in step S106 in the past with the position of the HMD 20 acquired in step S106 this time and thereby determines whether the HMD 20 has moved. If the HMD 20 has moved, the processing proceeds to step S112. In contrast, if the HMD 20 has not moved, the processing proceeds to step S130.

In step S112, the CPU 31A determines whether the HMD 20 has moved in one of a direction in which the HMD 20 faces and a direction opposite to the direction in which the HMD 20 faces, that is, whether the moving direction of the HMD 20 is one of a forward direction and a backward direction. If the HMD 20 moves in the direction in which the HMD 20 faces or in the opposite direction, that is, if the direction of the line of sight from the HMD 20 is one of the forward direction and the backward direction without being changed, the processing proceeds to step S114. In contrast, if the HMD 20 has moved in a direction different from the direction in which the HMD 20 faces or different from the opposite direction, for example, if the HMD 20 has moved upwards, downwards, leftwards, or rightwards, the processing proceeds to step S116.

In step S114, the presentation image acquired in step S108 is enlarged or reduced on the basis of a moving distance in a corresponding one of the forward direction and the backward direction. Specifically, if the HMD 20 has moved forward, the presentation image is enlarged at an enlargement ratio appropriate for a moving distance in the forward direction. In contrast, if the HMD 20 has moved backwards, the presentation image is reduced at a reduction ratio appropriate for a moving distance in the backward direction. An image having the surroundings of the reduced image may be displayed in such a manner that the surroundings are interpolated by using an image of the presentation image displayed before the moving. The enlargement ratio is calculated by using, for example, table data or a relation representing correspondence between the moving distance and the enlargement ratio. The reduction ratio is likewise calculated, by using, for example, table data or a relation representing correspondence between the moving distance and the reduction ratio.

In step S116, the CPU 31A determines whether the attitude of the HMD 20 is an attitude of facing a wall in the presentation image straight on. Specifically, the CPU 31A determines whether the angle β formed around the Y axis of the HMD 20 and acquired in step S106 matches one of the angles β1, β2, β3, and β4 formed around the Y axis included in the added information. The angles β1, β2, β3, and β4 are the angles formed at the time of facing the respective walls W1, W2, W3, and W4 straight on. If the angle β matches one of the angles β1, β2, β3, and β4, the CPU 31A determines that the attitude of the HMD 20 is an attitude of facing a wall in the presentation image straight on. Note that even if the angles do not match, but if a difference between the angles is within a range of several degrees, the CPU 31A may determine that the angles match.

If the attitude of the HMD 20 is not an attitude of facing a wall in the presentation image straight on, the processing proceeds to step S118. In contrast, if the attitude of the HMD 20 is an attitude of facing a wall in the presentation image straight on, the processing proceeds to step S120.

In step S118, the CPU 31A causes the display 22 of the HMD 20 to display a message for notification to face a wall straight on. This prompts the user US to change the position of the HMD 20 to face the wall straight on. This is because to detect a vanishing point in the presentation image 50 in step S120 (described later), the attitude of the HMD 20 facing a wall in the presentation image 50 straight on makes the detection of the vanishing point easier.

To cause the HMD 20 to face a wall in the presentation image 50 straight on, a message for notification of a direction in which the HMD 20 is to face may also be displayed on the display 22 of the HMD 20. Specifically, a direction in which the HMD 20 is to face is determined on the basis of an angle difference between the angle β acquired in step S106 and one of the angles β1, β2, β3, and β4 to make a notification of the direction. This makes easier to cause the HMD 20 to face a wall in the presentation image 50.

In step S120, the CPU 31A detects a vanishing point in the presentation image 50. The vanishing point is a point of intersection of lines parallel to each other in reality but depicted as lines not parallel in perspective. In step S120, for example, a publicly known edge detection process is executed on the presentation image 50 to detect the lines, and the point of intersection of the detected lines is detected as a vanishing point.

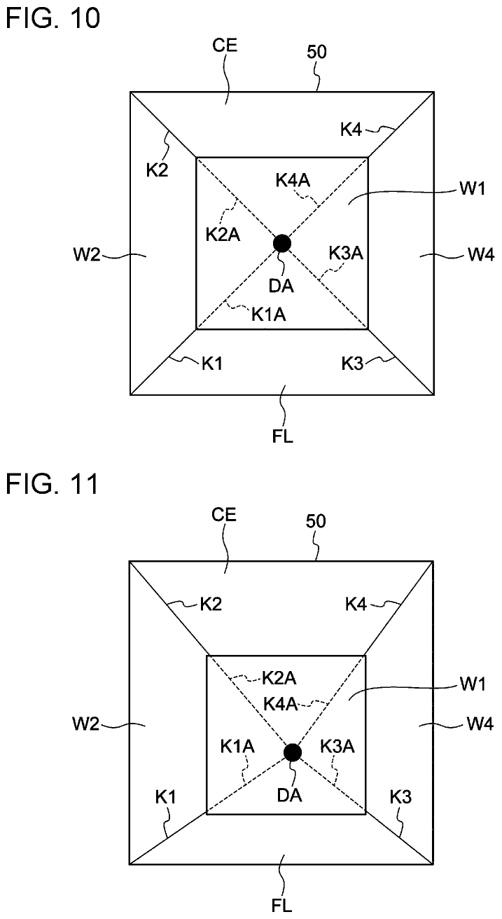

Since the full 360-degree spherical image 40 is a shot image of the room RM having the interior of a cuboid in this exemplary embodiment, boundaries between a floor FL, the ceiling CE, and the walls W1 to W4 are each a line. In addition, for example, if the presentation image 50 includes the floor FL, the walls W1, W2, and W4, and the ceiling CE as illustrated in FIG. 10, a boundary K1 between the floor FL and the wall W2 and a boundary K2 between the wall W2 and the ceiling CE are parallel to each other in reality but are not parallel in the presentation image 50. Likewise, a boundary K3 between the floor FL and the wall W4 and a boundary K4 between the wall W4 and the ceiling CE are parallel to each other in reality but are not parallel in the presentation image 50.

Accordingly, the point of intersection of lines K1A to K4A extended from the four boundaries K1 to K4 is a vanishing point DA. The lines K1A to K4A extended from the four boundaries K1 to K4 possibly do not intersect at one point but interest at multiple points. In this case, one of the points, the intermediate point of the lines, or another point may be set as the vanishing point.

To detect the vanishing point, for example, a publicly known edge detection process may be executed on the presentation image to detect boundaries, and the point of intersection of lines extended from the detected boundaries may be detected.

To detect the vanishing point accurately, the presentation image 50 is desirably an image shot indoor as in this exemplary embodiment. Specifically, the presentation image 50 desirably includes a ceiling, walls, a floor, and at least two boundaries therebetween. The floor and the ceiling are desirably horizontal, and adjacent walls desirably form a right angle. Further, the presentation image 50 is desirably an image having a wall viewed straight on.

In addition, the full 360-degree spherical image desirably has undergone zenith correction, that is, the horizontality of the presentation image has desirably been guaranteed.

In step S122, the CPU 31A determines whether the vanishing point DA is successfully detected in the vanishing point detection in step S120. If the vanishing point DA is detected successfully, the processing proceeds to step S124. In contrast, if the vanishing point DA is not detected successfully, the processing proceeds to step S126.

In step S124, the CPU 31A sets the vanishing point DA detected in step S120 as the reference point.

In contrast, in step S126, the CPU 31A sets the center point of the presentation image 50 as the reference point.

In step S128, the CPU 31A moves the reference point on the basis of the movement of the HMD 20 and recomposes the presentation image 50. Specifically, the CPU 31A calculates a moving distance on the basis of the position of the HMD 20 acquired in step S106 in the past and the position of the HMD 20 acquired in step S106 this time and moves the reference point on the basis of the calculated moving distance.

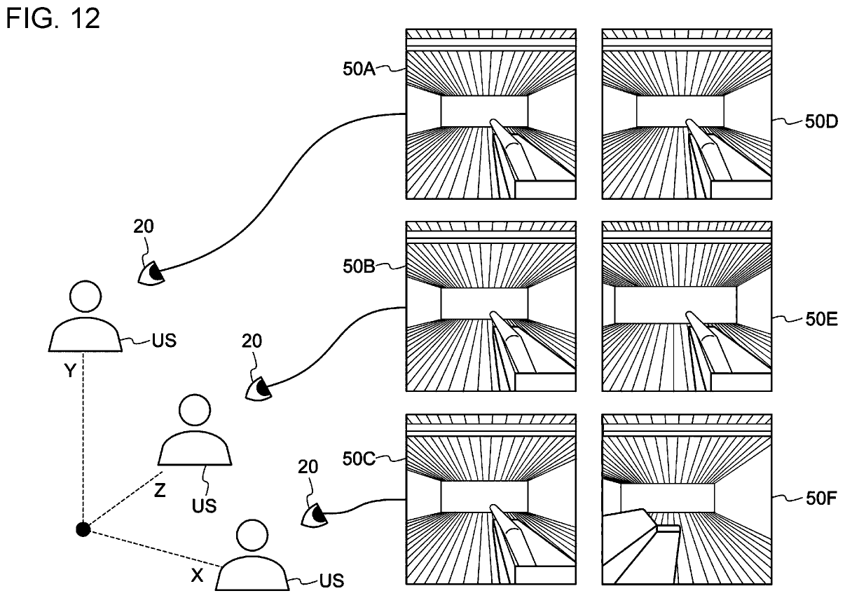

For example, if the user US wearing the HMD 20 stands up, and if the position of the HMD 20 moves L [cm] (for example, several tens of centimeters) from the reference position F in a height direction, that is, in the Y axis direction, the presentation image 50 needs to be recomposed to an image of a view from a position L [cm] higher than that in the original presentation image 50. Accordingly, if the vanishing point DA is detected in the center of the presentation image 50 as illustrated in FIG. 10, the presentation image 50 is recomposed as illustrated in FIG. 11 by moving the vanishing point DA downwards by the number of pixels corresponding to L [cm]. This leads to recomposition of the presentation image 50 performed on the basis of the movement of the HMD 20 and thus reduces the occurrence of a strange feeling.

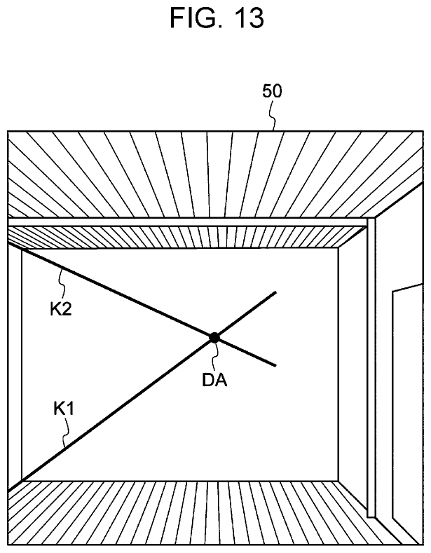

For example, if the presentation image 50 is not recomposed on the basis of the movement of the HMD 20, the presentation images 50A, 50B, 50C in the respective cases of the movement of the user US in the Y axis direction, in the Z axis direction, and in the X axis direction are basically identical as illustrated in FIG. 12. This causes the user US to have a strange feeling on occasions.

In contrast, in this exemplary embodiment, the presentation image 50 is recomposed on the basis of the movement of the HMD 20. In addition, how the presentation image 50 is recomposed depends on the direction in which the HMD 20 moves. Accordingly, for example, as illustrated in FIG. 12, when the user US moves upwards in the Y axis direction, a presentation image 50D recomposed in step S128 in FIG. 4 is an image of a view from a slightly higher point than that in the presentation image 50A not recomposed.

When the user US moves toward the wall in the Z axis direction, a presentation image 50E recomposed in step S114 in FIG. 4 is an image in which the wall in front is enlarged compared to the not recomposed presentation image 50B. When the user US moves rightwards in the X axis direction, a presentation image 50F recomposed in step S128 in FIG. 4 is an image having the point of view moved rightwards compared to the not recomposed presentation image 50C. This reduces a strange feeling of the user US.

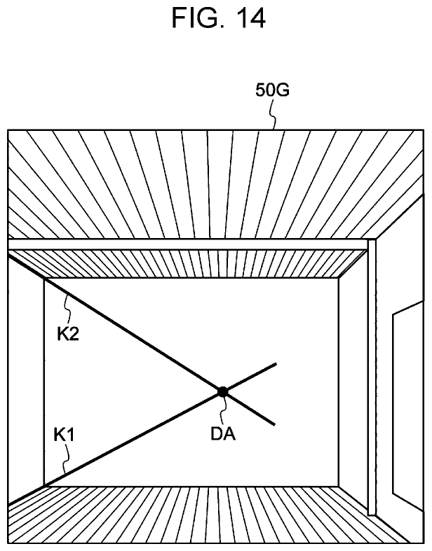

FIG. 13 illustrates a specific example of the presentation image 50 having the point of intersection of the boundaries K1 and K2 detected as the vanishing point DA. FIG. 14 illustrates a presentation image 50G in which the vanishing point DA in FIG. 13 is moved downwards because the HMD 20 is moved upwards. As described above, the presentation image 50G is such an image that has a point of view moved upwards. Since the presentation image 50 is recomposed in this manner on the basis of the movement of the HMD 20, that is, on the basis of the movement of the user US, a strange feeling of the user US is reduced compared to the case where the presentation image 50 is not recomposed, regardless of whether the user US moves.

The present disclosure has heretofore been described by using the exemplary embodiment. The scope of the present disclosure is not limited to the scope of the exemplary embodiment. Various modifications and improvements may be made to the exemplary embodiment without departing from the spirit of the present disclosure, and a modified or improved mode may also be included in the technical scope of the present disclosure.

For example, the configuration in which the HMD 20 and the information processing apparatus 30 are separate and independent has heretofore been described in this exemplary embodiment; however, the HMD 20 may have the functions of the information processing apparatus 30.

The mode in which the information processing program 35A is installed in the memory 35 has been described in this exemplary embodiment; however, the exemplary embodiment is not limited thereto. The information processing program 35A according to this exemplary embodiment may be provided in such a manner as to be stored in a computer readable storage medium. For example, the information processing program 35A according to this exemplary embodiment may be provided in such a manner as to be recorded in an optical disk such as a compact disc (CD)-ROM or a digital versatile disc (DVD)-ROM or in a semiconductor memory such as a universal serial bus (USB) memory or a memory card. The information processing program 35A according to this exemplary embodiment may also be acquired from an external apparatus via a communication network connected to the communication unit 34.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
cause a display device to display a presentation image that is part of a reference image of a viewing target shot at a predetermined reference position, the presentation image being based on an attitude of the display device used by a user and
recompose the presentation image when a position of the display device is changed, the presentation image being recomposed on a basis of movement of the display device.

2. The information processing apparatus according to claim 1,
wherein the processor is configured to
vary how the presentation image is recomposed, depending on a direction in which the display device moves.

3. The information processing apparatus according to claim 2,
wherein the processor is configured to
move a reference point in the presentation image and recompose the presentation image when the direction in which the display device moves is different from a direction in which the display device faces or different from a direction opposite to the direction in which the display device faces.

4. The information processing apparatus according to claim 3,
wherein the processor is configured to
recompose the presentation image by using a vanishing point in the presentation image set as the reference point.

5. The information processing apparatus according to claim 3,
wherein the processor is configured to
recompose the presentation image by using a center point in the presentation image set as the reference point, the presentation image being recomposed when a vanishing point in the presentation image is not detected.

6. The information processing apparatus according to claim 3,
wherein the presentation image is an image of a room having a wall, and
wherein the processor is configured to
recompose the presentation image when the attitude of the display device is an attitude of facing the wall straight on.

7. The information processing apparatus according to claim 4,
wherein the presentation image is an image of a room having a wall, and
wherein the processor is configured to
recompose the presentation image when the attitude of the display device is an attitude of facing the wall straight on.

8. The information processing apparatus according to claim 5,
wherein the presentation image is an image of a room having a wall, and
wherein the processor is configured to
recompose the presentation image when the attitude of the display device is an attitude of facing the wall straight on.

9. The information processing apparatus according to claim 2,
wherein the presentation image is an image of a room having a wall, and
wherein the processor is configured to
make notification when the direction in which the display device moves is different from a direction in which the display device faces or different from a direction opposite to the direction in which the display device faces and when the attitude of the display device is not an attitude of facing the wall straight on.

10. The information processing apparatus according to claim 9,
wherein the processor is configured to
make notification of a direction in which the display device is to face, the notification being made to cause the display device to face the wall straight on.

11. The information processing apparatus according to claim 2,
wherein the processor is configured to
recompose the presentation image by enlarging the presentation image when the direction in which the display device moves is a direction in which the display device faces or by reducing the presentation image when the direction in which the display device moves is a direction opposite to the direction in which the display device faces.

12. A viewing apparatus comprising:
a display device that displays a presentation image that is part of a reference image of a viewing target shot at a predetermined reference position; and
the information processing apparatus according to claim 1.

13. A non-transitory computer readable medium storing a program causing a computer to execute a process comprising:
causing a display device to display a presentation image that is part of a reference image of a viewing target shot at a predetermined reference position, the presentation image being based on an attitude of the display device used by a user; and
recomposing the presentation image when a position of the display device is changed, the presentation image being recomposed on a basis of movement of the display device.
